(19) United States
(12) Patent Application Publication
(10) Pub. No.: US 2016/0167923 A1
(43) Pub. Date: Jun. 16, 2016

(54) ELEVATOR CAR FRAME, A METHOD FOR INSTALLING AN ELEVATOR CAR FRAME, AND AN ELEVATOR

(71) Applicant: Antti PIRTTINIEMI, Vantaa (FI)

(72) Inventor: Antti PIRTTINIEMI, Vantaa (FI)

(21) Appl. No.: 14/947,531

(22) Filed: Nov. 20, 2015

(30) Foreign Application Priority Data
Dec. 10, 2014 (EP) 14197075.6

(51) Int. Cl. B66B 11/02; B66B 19/00

(52) U.S. Cl. CPC B66B 11/0206; B66B 11/0226; B66B 19/00

(57) ABSTRACT

An elevator car frame is disclosed. It comprises two side beams, each of them having a length and two ends, being at a distance from each other, being aligned substantially parallel to each other and their lengths being substantially the same. The elevator car frame further comprises a top cross beam and a bottom cross beam, each of them having a length and two ends, being at a distance from each other, being aligned substantially parallel to each other and their lengths being substantially the same. The top cross beam and the bottom cross beam are connected from their ends to the side beams for forming a closed and essentially rectangular frame. The elevator car frame is characterized in that the top cross beam and the bottom cross beam each comprise at least two modules being connected to each other, and optionally to a side beam, by an adjustable connection for folding the modules of the top cross beam and the bottom cross beam to allow reversibly reducing the size of the elevator car frame.

This application claims priority to European Patent Application No. EP14197075.6 filed on Dec. 10, 2014, the entire contents of which are incorporated herein by reference.

### TECHNICAL FIELD

The present disclosure relates to an elevator car frame, an elevator and a method for installing an elevator car frame.

### BACKGROUND ART

An elevator car frame, or an elevator car sling, is the structure supporting the elevator car. It is typically a steel frame comprising of two vertically aligned side beams, and two horizontally aligned cross beams. The elevator car is constructed inside the frame so that one horizontal beam extends below the elevator car floor and another above the ceiling of the elevator car. The horizontal beams are connected by two vertical beams located outside two opposing elevator car walls. Hoisting ropes or sheaves or—in case of a hydraulic elevator—the elevator ram, as well as guide shoes and safety gear are attached to the elevator car frame.

The size of the elevator car frame depends on the dimensions of the elevator car, which again is affected by the shaft dimensions, the positioning of the counterweight within the shaft and elevator type, among other things. Especially at modernization sites, the elevator car frame can have unique measurements.

Customarily, an elevator car frame is individually fabricated according to the measurements required by each elevator. Steel beams are welded or bolted together to form a frame with the desired measurements. The ready elevator car frame is transported to each location in its final shape, which is cumbersome and expensive. Further, since each elevator car frame is individually manufactured, finishing of the elevator installation is in part dependent of the timely delivery of the elevator car frame.

It is alternatively possible to construct the elevator car frame on-site from pre-manufactured components. In this case, correct parts for the elevator installation in question have to be delivered and the working conditions during assembly of the elevator car frame can vary. If wrong parts are erroneously brought to the installation site, the installation can suffer from delays.

### SUMMARY

An object of the present disclosure is to provide a versatile elevator car frame and an improved method for installing an elevator in an elevator shaft. A further object of the present disclosure is to solve at least one of the above problems related to prior-art solutions.

The elevator car frame and the method for its installation according to the present disclosure are in particular, but not only, intended for elevators, especially for passenger or cargo elevators of buildings.

The elevator car frame according to the present disclosure is characterized by what is presented in claim 1.

The method for installing an elevator car according to the present disclosure is characterized by what is presented in claim 14.

The elevator according to the present disclosure is characterized by what is presented in claim 16.

The elevator car frame according to the present disclosure and the method for elevator installation can offer at least one of the following advantages over prior art:

Elevator car frames may be pre-assembled and thereafter transported to the site of installation. This may allow a more efficient and cost-effective assembly process as the work can be performed in an optimized environment and in bulk scale.

The possibility of folding the elevator car frame may reduce the cost of transportation. The folded elevator car frames can be packaged before transportation to optimize space usage during transportation. Further, all necessary components for installation may be included in the transportation package to facilitate installation.

The size of the elevator car frame according to the present disclosure can be adjusted. This may allow an elevator car frame constructed with single specifications to be installed in locations with varying dimensions. The elevator car frame constructed with single specifications can further be used to accommodate variable elevator car platforms and car enclosures. This reduces the number of different parts required for installation and thus reduces the risk of delivering wrong components to the installation site.

### BRIEF DESCRIPTION OF DRAWINGS

The accompanying drawings, which are included to provide a further understanding of the invention and constitute a part of this specification, illustrate embodiments of the invention and together with the description help to explain the principles of the invention but the invention is not limited to the specific embodiments illustrated in the drawings. In the drawings:

FIG. 1 is an axonometric illustration of an elevator car frame according to the present disclosure in a folded configuration.

FIG. 2A is an axonometric illustration of an elevator car frame according to the present disclosure in a using configuration.

FIG. 2B presents the elevator car frame of FIG. 2A in a using configuration that is wider than in FIG. 2A.

FIG. 3 is an axonometric illustration of an elevator car frame according to the present disclosure with side beams comprising modules.

### DETAILED DESCRIPTION

In one aspect, an elevator car frame is disclosed. The elevator car frame comprises a first side beam and a second side beam, each of them having a length and two ends, being at a distance from each other, being aligned substantially parallel to each other and their lengths being substantially the same. The elevator car frame further comprises a top cross beam and a bottom cross beam, each of them having a length and two ends, being at a distance from each other, being aligned substantially parallel to each other and their lengths being substantially the same. The top cross beam and the bottom cross beam are connected from their ends to the side beams for forming a closed and essentially rectangular frame. The elevator car frame is characterized in that the top cross beam and the bottom cross beam each comprise at least two modules being connected to each other, and optionally to a side beam, by an adjustable connection for folding the modules of the top cross beam and the bottom cross beam to allow reversibly reducing the size of the elevator car frame.

By an elevator car frame, or an elevator car sling, is herein meant a structure that is designed to carry the majority of the weight of an elevator car. The supporting structures in an elevator car frame are the two side beams and the two cross beams. In addition, there are hoisting means and various safety and control devices mounted on the elevator car frame. The construction of such additional devices is known to the skilled person and their type, location and structure are regulated by local construction codes. In most applications, the elevator car frame is made of metal, such as steel. A combination of different metals can be used for different parts of the elevator car frame.

By an elevator car is herein meant the elevator car platform forming the floor of the elevator car, and the car enclosure forming the walls and the ceiling of the elevator car. The elevator car comprises further components required for the functioning of the elevator, such as electrical connections and driving controls.

The bottom cross beam supports the elevator car platform, i.e. the floor of the elevator. The bottom cross beam can have structures widening the beam throughout its length or at one or more points along its length. This is to improve the balancing and load bearing capacity of the elevator car platform. In hydraulic elevators, the ram makes contact with the bottom cross beam for moving the elevator car vertically. In a traction elevator, the top cross beam often receives the pull from the hoisting roping. Usually, the attachment for the hoisting roping or sheaves for it are mounted at least partly on the top cross beam. If there is more than one top cross beam in the elevator car frame, the roping attachment or sheaves can be placed also between the individual beams.

In traction elevators with an underslung elevator car frame, the hoisting roping is directed under the elevator car frame, typically by sheaves. In the elevator car frame according to the present disclosure, the sheaves for the hoisting roping can be mounted on bottom cross beam(s). Alternatively, structures of the side beams can be used together or instead of the bottom cross beam for this purpose. There can be two sheaves mounted on the bottom cross beam. There can alternatively be more than two, for example three or four sheaves in the elevator car frame, depending on how the hoisting roping is guided. The position, angle and size of the sheaves can be adjustable and different types of attachments known in the art can used for mounting them on the elevator car frame.

In one embodiment, the elevator car frame according to the present disclosure is an underslung elevator car frame, wherein the hoisting roping is guided by sheaves mounted on the bottom cross beam(s). In one embodiment, the sheaves are mounted on the side beams.

The top and bottom cross beams in the elevator car frame according to the present disclosure are aligned substantially parallel and of approximately the same length. By the length of a beam is herein meant the length that the beam has when it is in use. A modest length difference is possible for the cross beams. If the lengths of the cross beams differ from each other, this difference can be, for example, due to different additional devices that might be mounted on them. The top cross beam and the bottom cross beam are connected from their ends to the side beams. By an end of a cross beam is herein meant the 20% of the beam length closest to each tip of the beam. There can be more than one top cross beam and/or a bottom cross beam in an elevator car frame.

The side beams connect the top cross beam and bottom cross beam. They thus participate in the distribution of the forces exerted on the cross beams. The distance between the side beams depends on the elevator car to be mounted in the elevator car frame. Each of them can additionally support one of the elevator car walls. They usually also mediate the contact between the elevator car and the guide rails through guide shoes. Additionally, the side beams can share the functions of the top and bottom cross beams by, for example, directly receiving a part of the lifting force of the hoisting system.

The side beams in the elevator car frame according to the present disclosure are vertical when in use and aligned substantially parallel to each other. The first side beam and the second side beam are connected from their ends to the cross beams. By and end of a side beam is herein meant the 20% of the beam length closest to each tip of the beam. There can be more than one first side beam or second side beam in an elevator car frame according to the present disclosure.

In addition to the cross beams and side beams, there can be further structures supporting the elevator car. There may be beams or rods extending laterally from the connection points of the side beams and cross beams, in addition to which there can be further vertical beams or rods connecting the laterally extending rods or beams to form a cage-like structure. Also many types of oblique supporting beams or rods are known in the art and they can be incorporated into the elevator car frame according to the present disclosure.

The cross beams in the elevator car frame according to the present disclosure have a modular structure. This allows the cross beams to be folded, which in turn allows the side beams to be brought closer to each other thus reducing the space required by the elevator car frame. By such a folded configuration of the elevator car frame is herein meant the position of the elevator car frame in which at least some modules in the elevator car frame are at least to some extent folded and the beam in which the modules in question are located does not form a rigid structure.

The top cross beam and the bottom cross beam do not need to be identically designed. For example, in a traction elevator, the forces exerted on the top cross beam and the bottom cross beam have opposing directions: When the elevator is in use, the top cross beam is being pulled upwards by the hoisting machinery whereas the load inside the elevator car pushes the bottom cross beam downwards. Therefore, in many applications, the folding direction of the top cross beam and the bottom cross beam are opposite. In many cases, this design is also advantageous for the efficiency of the folded configuration: Both cross beams are folded towards the inside of the elevator car frame. The structure of the modules can be designed so that it allows the folding only to one direction. Alternatively, the placement or structure of one or more modules can be designed to prevent the folding to the unwanted direction. There are many ways obvious to the skilled person to achieve an unidirectional folding.

By substantially parallelly aligned cross beams and side beams, respectively, the elevator car frame in its using configuration is indicated. When the elevator car frame according to the present disclosure is not in use (i.e. not installed in an elevator shaft), it can be stored in the above-mentioned folded configuration. This way, the modular structure of the cross beams and/or side beams is used to reduce the size of the elevator car frame. In the folded configuration, the substantially parallel alignment of the beams is not necessarily present.

By a using configuration is herein meant the position of the elevator car frame in which it forms a rectangular frame and the side beams, the cross beams and their connections are rigid. By folding is herein meant the position of an adjustable connection wherein the parts being connected by the adjustable connection in question are at a different angle relative to each other than in the using configuration of the elevator car frame. In some embodiments, also the moving of adjacent parts relative to each other in the same direction, such as telescoping, or two parts sliding about each other, can be meant by folding. In practice, the modules within the beams form an angle of approximately 180° in the using configuration. The modules and/or beams at the connection between a cross beam and a side beam form an angle of approximately 90° in the using configuration.

The reduction in the space taken by the elevator car frame is reversible. This means that the elevator car frame can be expanded from the folded configuration to using configuration and vice versa. In many applications, it is possible to alternate between the using configuration and the folded configuration repeatedly. Often, it is not necessary to remove any components from the elevator car frame according to the present disclosure when changing between the configurations. In these situations, the loosening of adjustable connections is enough to change the configuration. Sometimes, securing means, such as bolts, screws or pins are removed when changing between the configurations.

Each of the cross beams comprises at least two modules. Alternatively, there can be three, four or more modules in a given cross beam. It is not necessary that the top cross beam and the bottom cross beam have the same number of modules. If the cross beam comprises two modules, each of them is connected from its one end to a side beam and from its other end to the adjacent module. At least the connection between the two modules is adjustable, so that the modules can be moved relative to each other and the space taken by the elevator car frame can be reduced. If there are three modules in a cross beam, two of them are connected to the side beams. The third module, located between the two other modules, is connected to them. Typically, both of the connections of the third module to the other two would be adjustable. If there are more than three modules in a cross beam, are numerous alternatives for the connections between the modules and between modules and side beams. Also the alternatives for which connections are adjustable are many. A suitable number of modules and there relative sizes, as well as the number and location of the adjustable connections can be optimized for different elevators, as is known to the skilled person.

In many embodiments, the connections between the side beams and cross beams are adjustable. Such a structure typically allows the elevator car frame to be folded in a smaller space and reduces the number of modules required in a cross beam for achieving an efficient reduction in the size of the elevator car frame.

In most embodiments, each module is rigid. The modules are connected to each other and optionally to a side beam by an adjustable connection. The connections can be made at the end of each module. However, the positioning of the connection can be effected in a number of different ways as long as the modularity and foldability of the cross beam is achieved. The adjustable connection can be in the middle portion of a module or extend over a substantial part of the length of the module.

The modules within a given beam do not need to be identical in structure. For example, the modules being connected to the side beams can have the same structure. If there are additionally modules that are connected only to other modules, they can have a different structure. It is possible that all modules in a given cross beam are identical. This might bring advantages in the manufacturing costs of the elevator car frame.

By an adjustable connection is herein meant a connection that allows the movement of the parts making contact through it, to be moved relative to each other. The parts to be connected can be, for example rotated, bent, folded or turned. The adjustable connection, however, has the property of being fixable to a position in which the elevator car frame is being used, i.e. in the using configuration. In some embodiments, it might be advantageous to be able to fix the elevator car frame also to the folded configuration.

In the using configuration, the elevator car frame according to the present disclosure is a rectangular structure, defined by the side beams and cross beams, inside which an elevator car can be fitted or constructed. The shape of the elevator car is not limited by the elevator car frame and any type of an elevator car known in the art can be used with the elevator car frame according to the present disclosure. Typically, the elevator car frame is located in the middle of the vertical cross section of the elevator car. This might be advantageous for the balancing of the elevator car. This symmetry, however, is not necessary and deviations from it are possible. There can be more than one elevator ca frame according to the present disclosure supporting a single elevator car.

In case there is more than one top cross beam, bottom cross beam, first side beam or second side beam in the elevator car frame, the beams in each of the positions can have the same structure or they can differ from each other.

In case a beam is constructed of modules, it is possible that in a given beam, there is more than one parallel module in one or more position along the beam, whereas in one or more other position along the beam, there is only one module.

In one embodiment, the first side beam and the second side beam comprise each at least two modules being connected to each other and optionally to a cross beam by an adjustable connection for folding the modules of the first side beam and the second side beam to allow reversibly reducing the size of the elevator car frame.

In addition to the top cross beam and the bottom cross beam, also the side beams can have a modular structure allowing the elevator car frame according to the present disclosure to be folded and its size thus being reduced. What is stated above for the modular structure of the cross beams can be applied to the side beams. However, the forces exerted on the side beams are mostly in the direction of the length of the beam and not perpendicular to it, as is the case for the cross beams. Therefore, connections that ascertain the stability of the beam in the direction of its length may thus be especially beneficial. Further, the side beams have typically the same set of auxiliary devices mounted on them and mirror each other more closely than the top cross beam and the bottom cross beam.

In some applications, all the connections in an elevator car frame according to the present disclosure are adjustable. In some applications, only one connection in in each of two opposing beams is adjustable. Any number of adjustable connections between these extremes is possible and the selection of the appropriate number and location of such connections is within the knowledge of the skilled person.

The adjustable connections can be designed so, that in addition to allowing the folding of the elevator car frame, they are fixable to the using configuration in more than one position. In practice, this means that with the same design, more than one size of an elevator car frame can be achieved. This might improve the flexibility of the installation and reduce the number of components needed for different installation sites.

In one embodiment, the modules of the cross beams are connected to each other by an adjustable connection for adjusting said distance between the first side beam and the second side beam. In other words, the length of the cross beams can be adjusted. Typically, the elevator car runs between two guide rails that are located on its two opposing sides. Each guide rail is fastened to the elevator shaft wall or other sturdy structure in the elevator shaft and guide shoes are mounted on the side beams of the elevator car frame to contact the guide rail. The width of the elevator car needs to match the distance between the guide rails quite closely to allow an appropriate contact between the guide shoes and the guide rail. In this embodiment, it is possible to accommodate installation sites having different distances between the guide rails. Further, the width of the elevator car frame is an important factor in determining the size of the elevator car. With an elevator car frame whose width can be adjusted, an elevator car frame manufactured with single specifications can be used for elevator cars of different sizes.

In one embodiment, the modules of the side beams are connected to each other by an adjustable connection for adjusting said distance between the top cross beam and the bottom cross beam. Analogously to the previous embodiment, also the height of the elevator car can be adjusted if the adjustable connections are designed to allow the adjustment of the side beam length in addition to the folding capability.

The different positions to which the adjustable connections can be fixed, can be stepwise or continuous. A stepwise design through, for example a row of corresponding holes in adjacent modules through which a bolt is installable, might be simple to construct. With a continuous design, on the other hand, it would be possible to cover a continuous range of beam lengths. There are several parameters affecting the selection of an appropriate alternative and it is within the knowledge of the skilled person to make such a selection.

A hinge can be used to make a connection between adjacent modules, or between a cross beam and a side beam, adjustable. The hinge can allow the turning of the parts relative to each other, but it can also allow other directions of movement. This is a case, for example, if there is an elongated opening in at least one of the components connected by the hinge and a piece can be fitted through both components. In many embodiments, the hinge is constructed so that it can be fixed to the using configuration without the use of numerous external components. Hinges can be used in a connection between modules of a beam or in a connection between a cross beam and a side beam.

In one embodiment, at least one, preferably all, adjustable connections between the side beams and the cross beams are hinges for folding the side beams and cross beams relative to each other.

In one embodiment, at least one, preferably all, adjustable connections between the modules are hinges for folding the modules relative to each other.

In one embodiment, a given cross beam and/or side beam comprises three modules and the cross beam and/or the side beam is foldable to one direction. Often, but not necessarily always, both the connections between the modules are adjustable.

It is possible to envisage also embodiments, in which a given cross beam and/or side beam comprises two modules and the cross beam and/or the side beam is foldable to one direction.

Designing the cross beams and the side beams foldable to only one direction can enhance the stability of the elevator car frame structure in its using configuration. For example, the structure of the modules can be designed so that it allows their folding relative to each other and/or to the adjacent beam only in one direction. Alternatively, the placement of one or more modules can be designed to prevent the folding to the unwanted direction. There are many ways obvious to the skilled person to achieve an unidirectional folding.

The folding direction of the top cross beam and the bottom cross beam can be opposite, since the forces exerted on them have mainly opposite directions. Taking this into account when designing the folding of the beams can further improve the stability of the elevator car frame in its using configuration. The folding direction of the top cross beam and the bottom cross beam can alternatively be the same, i.e. such that one of the beams folds towards the inside of the elevator car frame and the other one towards the outside. It is further possible that the cross beams fold to different directions so that they both fold outwards from the elevator car frame. It is, however, not necessary for a beam to fold in only one direction.

Also the folding direction of the side beams can be opposite, so that both of them fold towards the inside of the elevator car frame. They can also fold to opposite direction so that they both fold outwards. Alternatively, they can be foldable to the same direction as described above for the cross beams. Many combinations of the folding directions are thus possible, and the optimal one depends on the application for which the elevator car frame according to the present disclosure is used, and on which beams have the modular structure described herein.

In one embodiment, each cross beam and/or side beam is foldable towards the interior of the frame defined by the side beams and the cross beams. In this embodiment, the space inside the elevator car frame according to the present disclosure is used for the reduction of the size of the elevator car frame. In some applications, both the top cross beam and the bottom cross beam are foldable towards the inside of the elevator car frame. In some applications, all the beams comprising modules are foldable towards the inside of the elevator car frame. This design can be advantageous for the efficiency of the folded configuration.

However, as an alternative to an inward-folding elevator car frame, it is possible to design an elevator car frame, in which two opposing beams (for example the cross beams) would fold outwards and the other two beams (for example the side beams) would be brought close to each other, i.e. the distance between them would be reduced. In such an embodiment, the folded configuration of the elevator car frame would be long, but it would also be narrow, which might be beneficial in some applications.

In one embodiment, at least one, preferably all, adjustable connections between the modules are telescopic connections.

By a telescopic connection is herein meant a connection between two parts of a structure, each part having a length and the lengths being parallel, in which the parts are able to move relative to each other in the direction of their lengths. The movement allows the lengthening or shortening of the structure. Often, one of the parts being connected is fittable inside the other part. The degree to which one of the parts is inside the other one is reversibly adjustable and the parts can be fixed to a pre-determined position.

The telescopic connections can be combined with other types of adjustable connections, such as hinges. It is, for example, possible that the adjustable connections between two modules are telescopic connections and the adjustable connections between two beams are hinges.

In one embodiment, the adjustable connections between the modules, and/or between the side beams and the cross beams, are lockable to a predetermined position by locking means. In order to ascertain the rigidity of the using configuration of the elevator car frame according to the present disclosure, locking means can be used. There are many types of locking means that can be used for this purpose. In one embodiment, the locking means comprise one or more openings through which securing means, such as rods, screws or bolts are configured to be fitted. For example, if a connection between two modules is to be secured by the locking means, one of the modules can have an elongate opening and the other module can have a hole. The opening is elongate in the direction in which the positions of the two modules are adjustable. The hole and the opening are positioned relative to each other so that, in the using configuration, securing means can be fitted through both fixing the positions of the two modules. Often, the securing means is tightened in its place through threads, clips or the like.

In one embodiment, the elevator car frame comprises at least one stiffening member for securing the relative positions of a cross beam and a side beam. The elevator car frame can comprise further elements that assist in holding the positions of the modules and/or beams in the using configuration of the elevator car frame. Typically, they are separate elements from the beam and/or module structures. They are held in place with fastening means. Alternatively, they can be integral to the elevator car frame. In addition to guiding the right position of the elevator car frame in the using configuration, the stiffening member can also support the frame structures in holding the correct position. In one embodiment, the stiffening member(s) increase the rigidity of the frame. With the aid of stiffening members, the structure of the elevator car frame can be strengthened in a targeted manner. The extra support is given in the positions that might otherwise be the weakest and determine the load-bearing capacity of the elevator car frame, for example. Depending on the design of the elevator car frame and of the stiffening member(s), support in many different directions can be enhanced. Selection the appropriate design to give the right kind of support for each application belongs to the competence of the skilled person.

In one embodiment, the elevator car frame is installable to elevators having different specifications, such as dimensions or weight. The elevator car frame according to the present disclosure has the potential benefit of one frame design being usable in elevators with differing specifications. This is, however, not necessary and the elevator car frame according to the present disclosure can also be implemented in ways that allow a single using configuration having specific measurements. In such an application, strength, material and accessory parts can be optimized for a specific type of an elevator. Also in this case, the foldability of the elevator car frame might be advantageous for transport. Further, as the elevator car frame can be pre-constructed to a high degree, on-site installation work remains simple.

If the adjustable connections allow assembling the elevator car frame in several different using configurations, the same elevator car frame can be used in elevators with different specifications. This has the potential of reducing the number of parts required in its installation and thus its costs. Further, the delivery time of the elevator car frame to an installation site would be minimal, as it would not be necessary to assemble each elevator car frame only after its specifications are known. Instead, a reserve of pre-assembled elevator car frames could be kept in storage and delivered on-demand.

The elevator car frames can also be only partially pre-assembled beforehand and they can be finished upon installation.

In one aspect, a method for installing an elevator car frame is disclosed. The method is characterized in that it comprises the steps of

a) constructing an elevator car frame according to the present disclosure and optionally reducing its size by using the adjustable connections;

b) optionally packing the elevator car frame for transport;

c) optionally transporting the elevator car frame to the site of installation;

d) optionally unpacking the elevator car frame; and

e) assembling the elevator car frame, preferably between a pair of guide rails present in the elevators shaft, to fit the specifications of the elevator for which the elevator car frame is intended, and optionally locking the adjustable connections with locking means, and optionally with the stiffening member(s).

In step a) of the method according to the present disclosure, the elevator car frame is constructed in a workshop or on-site. It can be constructed in the folded configuration or in the using configuration. It is possible to install further elements, such as guide shoes or sheaves for hoisting roping, in the elevator car frame already at this stage.

If the elevator car frame is constructed in the using configuration, it is typically folded for transport. The adjustable connections are used for folding. Although the advantages of the method according to the present disclosure are most prominent if the elevator car frame is folded before transport, this is not necessary. Especially if the elevator car frame is constructed on-site, the size reduction is not necessary. A common set of components can be used in multiple installation sites and the elevator car frame may thus still manifest benefits in respect to prior-art solutions.

If the elevator car frame is constructed in a workshop or other location distant to the site of installation, it can be packed for transport in step b) of the method. In the packaging, the elevator car frame is protected from damage during transport. The package may contain supports or holders for keeping the elevator car frame steady. The transport package can be designed to facilitate transport. It can be designed to be stackable and/or to contain brackets or lugs for lifting or fastening the package during transport.

Packaging the elevator car frame might allow the inclusion of all components necessary for the installation in the package to ascertain the their availability upon installation. In one embodiment of the method, in step b), all necessary components for installing the elevator car frame at the site of installation are packed for simultaneous transport.

If the elevator car frame is constructed in a workshop or other location distant to the site of installation, it can be transported to the installation site with or without packaging in step c) of the method. When it is constructed on-site, its transportation is not necessary.

If the elevator car frame is packed for transport, it needs to be unpacked in step d) of the method before installation. Beneficially, at this stage the intactness of the elevator car frame is controlled and the presence of the optional installation components is ascertained.

In step e), the elevator car frame is assembled. It is unfolded and secured to the using configuration. The unfolding can take place between two guide rails present in the elevator shaft. When in use, the elevator car will run between the guide rails and the contact to them is mediated by the elevator car frame. If the elevator car frame is unfolded between the guide rails, its width will be practical to adjust based on the guide rails. Also all the necessary contact elements for the guide rails, such as guide shoes, can be directly installed.

Locking means and stiffening members may be used during installation if they are present. Also “self-locking” structures are possible (for example parts that are foldable only in one direction or parts that will be locked in place through moving components once they are brought into the using configuration). After the elevator car frame has been assembled, its installation follows procedures known in the art.

In one aspect, an elevator is disclosed. It is characterized in that it comprises an elevator car frame according to the present disclosure. The elevator can be any type of a cargo elevator or a passenger elevator known in the art.

The elevator car frame according to the current disclosure can be used already in the construction phase of the elevator. For example, a temporary working platform can be assembled on it for installing the guide rails or other elevator parts in the elevator shaft. The temporary structures can later be replaced by the elevator car. Alternatively, the elevator car can be built directly in the elevator car frame.

### DESCRIPTION OF DRAWINGS

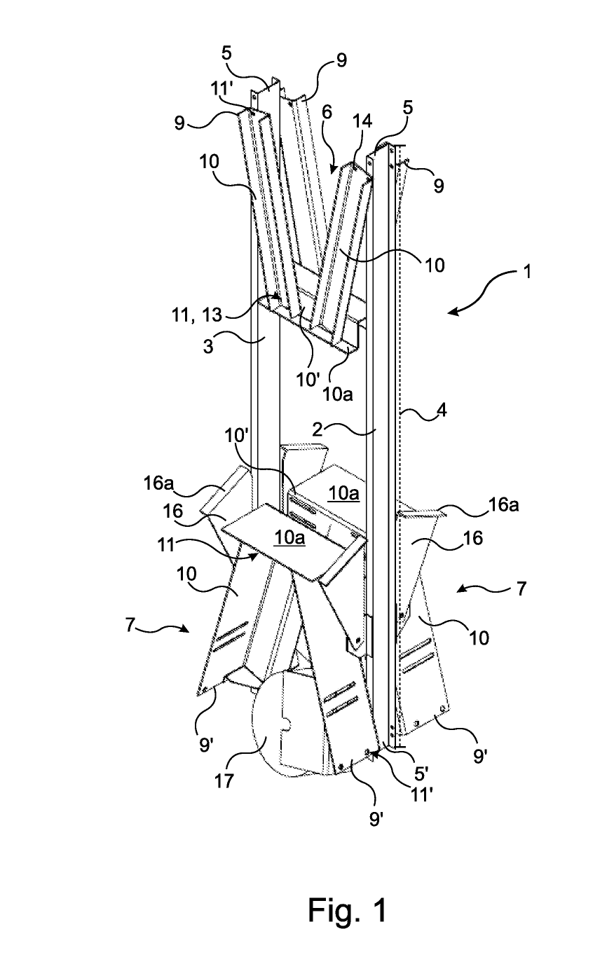

FIG. 1 presents an embodiment of an elevator car frame 1 according to the present disclosure in a folded configuration. Accessory devices, such as safety equipment and attachments for the hoisting roping are omitted from the figure for clarity.

The elevator car frame 1 of FIG. 1 comprises one first side beam 2 and one second side beam 3. The length 4 of the side beams is denoted by a dashed line 4. The elevator car frame 1 also comprises one top cross beam 6 and two bottom cross beams 7. The length 4 of the side beams 2, 3 is approximately equal to the distance between the top cross beam 6 and the bottom cross beam 7. In some embodiments, the distance between the cross beams 6, 7 might be shorter than the length of the side beams 2, 3. This might be due to, for example, the structure of the connections 11′ between the side beams 2, 3 and the cross beams 6, 7 or the positioning of equipment attached to the side beams 2, 3 and/or to the cross beams 6, 7.

The cross beams 6, 7 are connected from their ends 9, 9′ to the ends 5, 5′ of the side beams 2, 3. The connections between the cross beams 6, 7 and the side beams 2, 3 are adjustable connections 11′.

The top cross beam 6 comprises five modules 10, 10′. Four of the modules 10 (i.e. the outer modules 10) are connected from their ends 9 to the side beams 2, 3 through adjustable connections 11′. There are two parallel outer modules 10 connected to each of the side beams 2, 3. The fifth module 10′ (i.e. the middle module 10′) differs in its structure from the other four modules 10. All the four outer modules 10 are connected to the fifth module 10′ through adjustable connections 11. The profile of the fifth module 10′ comprises a shoulder 10a on its both sides in the direction of its length. The shoulder 10a is formed to allow the folding of the top cross beams 6 to only one direction. This direction is towards the inside of the elevator car frame 1, as is depicted in FIG. 1.

Both bottom cross beams 7 comprise three modules 10, 10′. There are two modules 10 (i.e. the outer modules 10) connected to the side beams 2, 3 through adjustable connections 11′. The third module 10′ (i.e. the middle module 10′) in each bottom cross beam 7 functions analogously to the fifth module 10′ of the top cross beam 6: It comprises a shoulder 10a and thus allows the folding of the bottom cross beam 7 in one direction. The direction in the embodiment of FIG. 1 is towards the inside of the elevator car frame 1. The shoulder 10a of the third module 10′ of the bottom cross beam 7 is wider and the remaining structure of the third module 10′ narrower than in the corresponding part in the top cross beam 6. The wider shoulder is complemented by equally wide profiles of the two outer modules 10. This reflects the bottom cross beam 7 being the supporting structure for the elevator car platform. The wider shoulder 10a and the wider profiles of the outer modules 10 might improve the balance of the elevator car platform and allow more space for possible attachment means for securing the platform to the bottom cross beam 6. This width difference between the two cross beams 6, 7 also demonstrates the possibility of designing the cross beams 6, 7 independently of each other.

Instead of the middle modules 10′ comprising the shoulders 10a, it would be possible for the outer modules 10 to have shoulders 10a or other structures limiting the direction of the elevator car frame 1 folding. For example, protrusions of variable shape as well as indentations and grooves in the modules 10, 10′ or in the side beams 2, 3 could be used to this end.

In the embodiment of FIG. 1, the elevator car frame 1 is in a folded position. To bring it to the using configuration, the middle modules 10′ of the top cross beam 6 and the bottom cross beams 7 are brought towards the outside of the elevator car frame 1. This forces the outer modules 10 of both cross beams 6, 7 to approach an angle of 90° in respect to the side beams 2, 3. The side beams 2, 3 are simultaneously brought further away from each other. When the angle between the side beams 2, 3 and the outer modules 10 of both cross beams 6, 7 is approximately 90°, the modules 10, 10′ form a straight beam that cannot continue its unfolding movement further and the using configuration of the elevator car frame 1 is achieved.

The elevator car frame 1 of FIG. 1 cannot be folded further towards the inside of the elevator car frame 1 than depicted in FIG. 1, as the middle module 10′ of the top cross beam 6 does not allow the movement of the side beams 2, 3 closer to each other. However, many embodiments can be envisaged in which the modules 10, 10′ would allow bringing the two side beams 2, 3 closer to each other in the folded configuration. For example, the cross beam 6, 7 structures could be foldable so, that the modules 10′ or parts thereof between the side beams 2, 3 would not be in at a right angle to the side beams 2, 3 in the folded configuration. The more the middle modules 10′ would be tilted from right angle, the shorter would the required space between the side beams 2, 3 be. Alternatively, all the cross beam 6, 7 structures could be located elsewhere than between the side beams 2, 3 in the folded configuration.

The adjustable connections 11, 11′ between the modules 10, 10′ and between the modules 10 and the side beams 2, 3 can be designed to comprise locking means 13. Alternatively, the locking means 13 can be absent. In the embodiment depicted in FIG. 1, the cross beams 6, 7 only fold in one direction and this direction is selected according to the direction of the forces exerted on the elevator car frame 1. Therefore, the locking means 13 are not necessary. In other words, the structure of the modules 10, 10′ is such that when in use, the elevator car frame 1 will not collapse even in the absence of specific locking means 13. The structure of the elevator car frame 1 can be further strengthened by the elevator car platform and enclosure built inside it.

In many applications, however, locking means are present. Especially in adjustable connections 11′ between the side beams 2, 3 and the cross beams 6, 7, locking means 13 can be used to strengthen the connection between the beams 2, 3, 6, 7. The locking means 13 can fulfil this purpose even if they are not necessary for the position of the beams 2, 3, 6, 7 relative to each other. Using sturdy locking means 13 comprising securing means 15, such as screws or bolts, might increase the load-bearing capacity of the elevator car frame 1. The locking means 13 can be effected in many different ways. One alternative is to have openings 14 in the beams 2, 3, 6, 7. The positioning of the openings 14 can be designed so that when the elevator car frame 1 is in the using configuration, the location of the openings 14 in the beams to be connected (i.e. in a side beam 2, 3 and a cross beam 6, 7) corresponds at least partly. This allows securing means 15 to be inserted through the openings 14 for fixing the beams 2, 3, 6, 7 to their positions. The securing means 15 are optionally tightenable. The securing means 15 can be pre-assembled in the elevator car frame 1 before it is transported to the installation site. Alternatively, the securing means can be incorporated into the elevator car frame 1 during installation.

The elevator car frame 1 of FIG. 1 further comprises stiffening members 16. In this embodiment, the stiffening members 16 are located at the adjustable connection 11′ between the side beams 2, 3 and the bottom cross beam 7. Each adjustable connection 11′ between a side beam 2, 3 and a bottom cross beam 7 is equipped with a stiffening member 16. However, it would be possible to have stiffening members 16 at the adjustable connection 11′ between the side beams 2, 3 and the top cross beam 6 in addition to, or instead of, stiffening members 16 located as in FIG. 1.

The stiffening members 16 of FIG. 1 are metal plates hinged to a side beam 2, 3. Their shape is designed to correspond to the angle between the bottom cross beam 7 and the side beam 2, 3. The stiffening member 16 comprises a lip 16a which is configured to be set against an outer module 10 of the bottom cross beam 7 and to be fastenable to it. The lip 16a comprises means to secure the position of the stiffening member 16. In the embodiment of FIG. 1, each stiffening member 16 has the approximate shape of a right-angled triangle. In the using configuration, the right angle is located at the adjustable connection 11′ between the bottom cross beam 7 and the side beam 2, 3. In FIG. 1, each stiffening member 16 is turned away from the bottom cross beam 7, thus allowing the bottom cross beams 7 to be folded and the folded configuration on of the elevator car frame 1 to be achieved.

The stiffening member could be in many alternative ways. It could, for example be only a rod being hinged to one of the beams to be connected and fastenable to the other beam. It could also be an L-shaped structure similarly attachable. Also rods and corresponding slots in various positions and directions crossing adjustable connections 11, 11′ could be used in stiffening the elevator car frame 1.

In FIG. 1, the elevator car frame 1 is of the underslung type and sheaves 17 are used for directing the hoisting roping (not shown) under the elevator car frame 1. The sheaves 17 are attached to the bottom cross beams 7 so that each of them is attached to different cross beam 7, and one of them is closer to the first side beam 2 and the other closer to the second side beam 3. Only one of the sheaves 17 is visible. The sheaves 17 are oriented to provide a symmetrical path for the hoisting roping relative to the center of mass of the elevator car frame 1. The position and the rolling direction of the sheaves 17 are adjustable.

The positioning of the sheaves 17 can be fixed beforehand or it can be adjusted during the installation of the elevator car frame 1 or when the hoisting roping is installed.

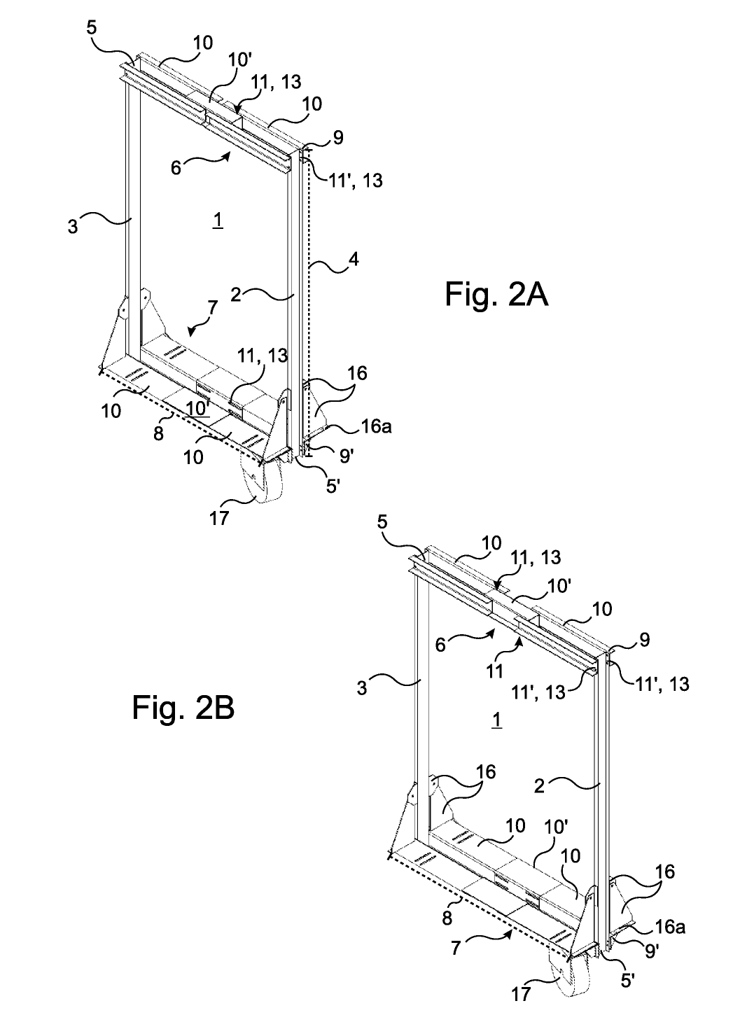

FIG. 2A is an axonometric illustration of the elevator car frame 1 of FIG. 1 in a using configuration. In addition to the features presented above, the length 8 of the cross beams 6, 7 is denoted with a dashed line 8. The length 8 of the cross beams 6, 7 is approximately equal to the distance between the side beams 2, 3. However, in some embodiments, it might be that the cross beams 6, 7 are longer than the distance between the side beams 2, 3. This might be due to, for example, the structure of the connections 11′ between the side beams 2, 3 and the cross beams 6, 7 or the positioning of equipment attached to the side beams 2, 3 and/or to the cross beams 6, 7.

In FIG. 2A, the cross beams 6, 7 are straight and rigid at least in one vertical direction. The locking means 13 present at the adjustable connections 11, 11′ provide further rigidity to the cross beams 6, 7 in additional directions. However, the locking means 13 are not always necessary and if they are present, they do not need to be used in all adjustable connections 11, 11′. The lip 16a of the stiffening member 16 rests against the bottom cross beam 7. Means to secure the position of the stiffening member 16 can be used to further strengthen the structure of the elevator car frame 1.

In FIG. 2A, the stiffening members 16 are turned towards the bottom cross beam 7 so that the right angle of the stiffening member 16 is located at the adjustable connection 11′ between the bottom cross beam 7 and the side beam 2, 3.

The sheave 17 is shown positioned approximately in the running direction of the hoisting roping. Its position can be further adjusted during the installation of the hoisting roping. In the embodiment of FIG. 2A, there are two sheaves 17. However, it would be possible that there are, for example, four sheaves, one at each end of both bottom cross beams 7.

FIG. 2B presents an elevator car frame 1 of FIG. 2A in a using configuration that is wider than in FIG. 2A. In other words, the length 8 of the cross beams 6, 7 is greater than in FIG. 2A. Accordingly, the distance between the side beams 2, 3 is longer.

This extension in the length 8 of the cross beams 6, 7 is achieved by adjustable connections 11 that allow the adjustment the position of the modules 10, 10′ relative to each other in the using configuration. In other words, the adjustable connections not only allow the turning of the modules 10, 10′ relative to each other, but also the movement in the direction of the beam length 4,8. This adjustability can be achieved in many ways. One alternative is that there are openings in the middle module 10′ extending in the direction of the cross beam 6, 7. The openings can be of different shape, for example comprising indentations or notches at one or more positions along their length to assist the correct positioning of the modules 10, 10′ relative to each other. The outer modules can have corresponding shaping. Additional components can be utilized to secure the positioning of the modules 10, 10′.

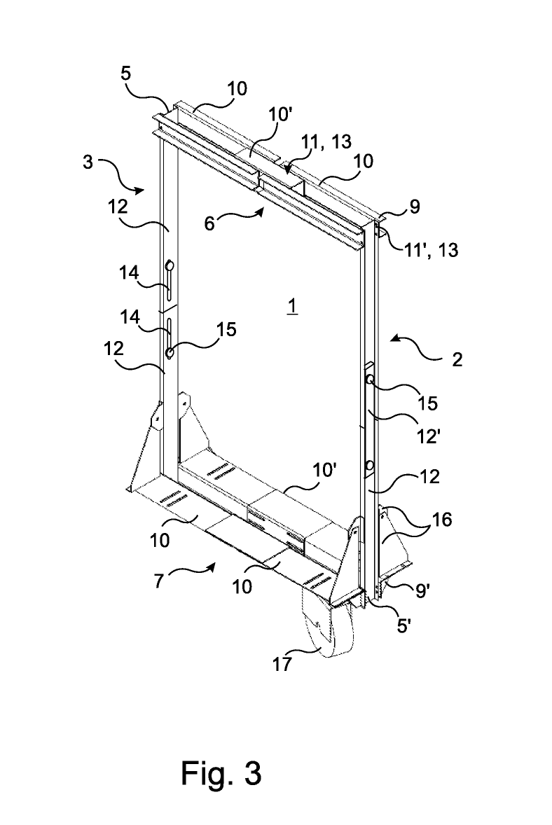

FIG. 3 is an axonometric illustration of an elevator car frame 1 according to the present disclosure with side beams 2, 3 comprising modules.

In addition to the features described above, the side beams 2, 3 of FIG. 3 comprise modules 12, 12′ for folding the side beams 2, 3 and thus reversibly reducing the size of the elevator car frame 1. The functioning of the modules 12, 12′ in the side beams 2, 3 is analogous to the modules in the cross beams 6, 7. However, the direction of the forces exerted on the side beams 2, 3 is the direction of the side beam 2, 3 in the using configuration of the elevator car frame 1. This needs to be taken into account in the design of the parts to exclude the possibility of the parts slipping in this direction. Several alternative designs remain available for the skilled person to accomplish such design.

In FIG. 3, securing means 15 is used to connect the middle module 12′ from its both ends to the respective outer modules 12 through openings 14 in the outer modules 12. When the securing means 15, which in this case are bolts 15, are tightened, a rigid beam is achieved. When the elevator car frame 1 of FIG. 3 is folded to the folded configuration, at least one of the securing means 15 is loose, the outer modules 12′ can be taken slightly apart and folded. The side beams 2, 3 are thus folded sideways to the side of the elevator car frame 1. This option is also available for the cross beams 6, 7 in some embodiments. The elongated form of the openings 14 allows margin for movement during the folding. Alternatively, the openings 14 can be holes 14, of which there can be several along the length of the modules 12 to allow the construction of an elevator car frame 1 with variable side beam 2, 3 length 4.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An elevator car frame comprising
a first side beam and a second side beam, each of them having a length and two ends, being at a distance from each other, being aligned substantially parallel to each other and their lengths being substantially the same, and
a top cross beam and a bottom cross beam, each of them having a length and two ends, being at a distance from each other, being aligned substantially parallel to each other and their lengths being substantially the same;
the top cross beam and the bottom cross beam being connected from their ends to the side beams for forming a closed and essentially rectangular frame;
wherein the top cross beam and the bottom cross beam each comprise at least two modules being connected to each other, and optionally to a side beam, by an adjustable connection for folding the modules of the top cross beam and the bottom cross beam to allow reversibly reducing the size of the elevator car frame.

2. The elevator car frame according to claim 1, wherein the first side beam and the second side beam comprise each at least two modules being connected to each other and optionally to a cross beam by an adjustable connection for folding the modules of the first side beam and the second side beam to allow reversibly reducing the size of the elevator car frame.

3. The elevator car frame according to claim 1, wherein the modules of the cross beams are connected to each other by an adjustable connection for adjusting said distance between the first side beam and the second side beam.

4. The elevator car frame according to claim 1, wherein the modules of the side beams are connected to each other by an adjustable connection for adjusting said distance between the top cross beam and the bottom cross beam.

5. The elevator car frame according to claim 1, wherein at least one, preferably all, adjustable connections between the side beams and the cross beams are hinges for folding the side beams and cross beams relative to each other.

6. The elevator car frame according to claim 1, wherein at least one, preferably all, adjustable connections between the modules are hinges for folding the modules relative to each other.

7. The elevator car frame according to claim 1, wherein a given cross beam and/or side beam comprises three modules and the cross beam and/or the side beam is foldable to one direction.

8. The elevator car frame according to claim 7, wherein each cross beam and/or side beam is foldable towards the interior of the frame defined by the side beams and the cross beams.

9. The elevator car frame according to claim 1, wherein at least one, preferably all, adjustable connections between the modules are telescopic connections.

10. The elevator car frame according to claim 1, wherein the adjustable connections between the modules, and/or between the side beams and the cross beams, are lockable to a predetermined position by locking means.

11. The elevator car frame according to claim 1, wherein the elevator car frame comprises at least one stiffening member for securing the relative positions of a cross beam and a side beam.

12. The elevator car frame according to claim 11, wherein the stiffening member(s) increase the rigidity of the frame.

13. The elevator car frame according to claim 1, wherein the elevator car frame is installable to elevators having different specifications, such as dimensions or weight.

14. A method for installing an elevator car frame, wherein it comprises the steps of
a) constructing an elevator car frame according to any of the preceding claims and optionally reducing its size by using the adjustable connections;
b) optionally packing the elevator car frame for transport;
c) optionally transporting the elevator car frame to the site of installation;
d) optionally unpacking the elevator car frame; and
e) assembling the elevator car frame, preferably between a pair of guide rails present in the elevator shaft, to fit the specifications of the elevator for which the elevator car frame is intended and optionally locking the adjustable connections with locking means, and optionally with the stiffening member(s).

15. The method according to claim 14, wherein in step b), all necessary components for installing the elevator car frame at the site of installation are packed for simultaneous transport.

16. An elevator, wherein it comprises an elevator car frame according to claim 1.
